(19) United States
(12) Patent Application Publication
(10) Pub. No.: US 2014/0349907 A1
(43) Pub. Date: Nov. 27, 2014

(54) COMPACT FLUID LAUNDRY DETERGENT COMPOSITION

(71) Applicant: The Procter & Gamble Company, Cincinnati, OH (US)

(72) Inventors: Gayle Marie FRANKENBACH, Cincinnati, OH (US); James William HOLDER, Fort Thomas, KY (US); Stephen Joseph HODSON, Franklin, OH (US); Jan Richard DAVIS, Harlan Township, OH (US); Gregory Thomas WANING, Fairfield, OH (US)

(73) Assignee: The Procter & Gamble Company, Cincinnati, OH (US)

(21) Appl. No.: 14/284,422

(22) Filed: May 22, 2014

Related U.S. Application Data
(60) Provisional application No. 61/827,373, filed on May 24, 2013.

(51) Int. Cl. C11D 1/02; C11D 3/20; C11D 3/386

(52) U.S. Cl. CPC C11D 1/02; C11D 3/38627; C11D 3/2075; C11D 3/38618; C11D 3/38636
USPC 510/321; 510/338

(57) ABSTRACT

The present invention relates to low pH, compact fluid laundry detergent compositions comprising branched surfactants.

### FIELD OF THE INVENTION

The present invention relates to low pH, compact fluid laundry detergent compositions comprising branched surfactants.

### BACKGROUND OF THE INVENTION

Fluid laundry products, such as liquids, gels, pastes and the like, are preferred by many consumers over solid detergents. Many consumers also have a desire to conserve resources and eliminate what they perceive as waste or unnecessary, without a noticeable or significant reduction in the performance of the product. Consequently, there is renewed interest in the concentrated or so-called compact laundry product. However, compaction is not as simple a solution as perceived by consumers. A reduction or increase in one or more of the components of a fluid laundry product, such as water, solvent, or surfactant, to arrive at a concentrated or compact formulation, means that the relative amount of each component is different as compared to the amount present in a non-compact or dilute product. Thus, significant effort is required to produce a compact product that has comparable performance to a non-compact or dilute product.

For example, one known way of delivering desired surfactancy or cleaning in a compact product is to use nonionic surfactants, which are capable of delivering cleaning that is comparable to the cleaning delivered by anionic surfactants. Nonionic surfactants, however, are low foaming as compared to anionic surfactants. Consequently, a compact, nonionic-surfactant-based laundry detergent may be perceived by a consumer as not performing as well as a non-compact, anionic-surfactant-based product, given that consumers tend to equate foaming with cleaning performance. And, it is difficult to increase the amount of higher-foaming surfactant, e.g., anionic surfactant, in order to increase foam, without adversely affecting product stability or product dispensability.

Thus, there remains an ongoing need for a concentrated fluid laundry detergent that is comparable in performance to existing non-compact laundry detergents. It has been found that an anionic-surfactant-based, concentrated laundry detergent, which has comparable performance to a non-compact product, can be formulated using a branched, anionic surfactant at a low pH.

### SUMMARY OF THE INVENTION

One aspect of the invention relates to a compact fluid laundry detergent composition comprising from about 30% to about 50%, by weight of the composition, of a surfactant system, where the surfactant system comprises from about 35% to about 70%, by weight of the surfactant system, of a branched anionic surfactant; from about 5% to about 15%, by weight of the composition, of a water soluble organic acid; where the composition has a pH of from about 2 to about 7, measured neat.

Another aspect of the invention relates to methods of cleaning soiled materials. Such methods include pretreatment of soiled material comprising contacting the soiled material with the detergent compositions of the invention.

### DETAILED DESCRIPTION OF THE INVENTION

Features and benefits of the various embodiments of the present invention will become apparent from the following description, which includes examples of specific embodiments intended to give a broad representation of the invention. Various modifications will be apparent to those skilled in the art from this description and from practice of the invention. The scope is not intended to be limited to the particular forms disclosed and the invention covers all modifications, equivalents, and alternatives falling within the spirit and scope of the invention as defined by the claims.

As used herein, the articles “a” and “an” when used in a claim, are understood to mean one or more of what is claimed or described.

As used herein, “low pH detergent composition” refers to a detergent composition having a pH ranging from about 2 to about 7, measured neat. In some aspects, the detergent compositions described herein have a neat pH of from about 2 to about 7, or from about 2.5 to about 6, or from about 3 to about 5.5, or from about 4 to about 5.5.

As used herein, “compact” or “concentrated” refers to a liquid composition that comprises less than about 35% water by the weight of composition.

As used herein “recommended doses” refers to the amount of compact fluid laundry detergent composition that a consumer should use in any particular usage situation. The recommended dose generally ranges from about 5 g to about 50 g per washload.

In another embodiment, the article of commerce has the following recommended doses in function of water hardness and soil level: low soil or soft water dosage is 10 ml to 40 ml; medium soil or medium water hardness water dosage 20 to 50 ml; high soil or high water hardness water dosage 30 to 70 ml. In another embodiment, the water insoluble container has a capacity of may contain from about 3 to about 50, specifically from about 6 to about 50, recommended doses of the compact fluid laundry detergent composition. In another embodiment, the water insoluble container has a volume of from 250 ml to 1500 ml and a dose capacity of from about 6 to about 50 recommended doses.

As used herein, the term ‘liquid” includes liquid, paste, wax, and gel compositions. The liquid composition may comprise a solid, including a powder or an agglomerate, e.g., micro-capsules, beads, noodles, or one or more pearlized balls. Such a solid element may provide a technical benefit or an aesthetic effect.

As used herein, the terms “include,” “includes,” and “including” are meant to be non-limiting.

As used herein, the terms “substantially free of” or “substantially free from” means that the indicated material is at the very minimum not deliberately added to the composition to form part of it, or, preferably, is not present at analytically detectable levels. It is meant to include compositions whereby the indicated material is present only as an impurity in one of the other materials deliberately included.

As used herein, all concentrations and ratios are on a weight basis of the liquid cleaning composition unless otherwise specified.

Unless otherwise noted, all component or composition levels are in reference to the active portion of that component or composition, and are exclusive of impurities, for example, residual solvents or by-products, which may be present in commercially available sources of such components or compositions.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Cleaning Compositions

As used herein the phrase “cleaning composition” includes compositions and formulations designed for cleaning a substrate or soiled material. Such substrates include flexible materials consisting of a network of natural or artificial fibers, including natural, artificial, and synthetic fibers, e.g., cotton, linen, wool, polyester, nylon, silk, acrylic, or blends thereof, and hard surfaces, including natural, artificial, or synthetic surfaces, e.g., tile, granite, grout, glass, composite, vinyl, hardwood, metal, cooking surfaces, plastic, or blends thereof. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, liquid hand dishwashing composition, detergent contained on or in a porous substrate or nonwoven sheet, automatic dish-washing agent, hard surface cleaner, and other suitable forms that may be apparent to one skilled in the art in view of the teachings herein. Such compositions may be used as a pre-laundering treatment, a post-laundering treatment, may be added during the rinse or wash cycle of the laundering operation, or used in homecare cleaning applications. The cleaning compositions may have a form selected from liquid, single-phase or multi-phase unit dose, pouch, gel, paste.

Typically, the cleaning compositions disclosed herein are low pH, compact fluid laundry detergent compositions that comprise branched surfactants, typically a branched anionic surfactant. Without intending to be bound by theory, it is generally shown that pH adjustments can be used to change the microstructures, and thus the appearance and rheology, of detergent compositions.

Appearance and rheology are aesthetic components of detergent compositions that are known to have a significant impact on consumer acceptance. Typically, as the ionic strength of the composition goes up, hydrophobic materials, such as surfactant, experience a higher degree of exclusion and precipitation from the aqueous phase. Even in dilute formulations, high ionic strength poses problems for achieving stability, desirable rheology, and acceptable aesthetics. These problems become even more evident when the composition becomes more concentrated in surfactant and charged active species (chelant, polymers, organic acids used as builders, etc.).

However, as the pH of the composition is reduced, the ionic strength decreases, and there is less drive for surfactant microstructures to precipitate out of the composition. Furthermore, as the pH is reduced, there may be less need to neutralize surfactants, which results in both a reduction of ionic strength (because the counterion concentration is reduced) and an increase in available formulation space (into which efficacious cleaning components may be added). Additionally, such a compact formulation may provide a reduction in the level of solvent, nonionic surfactants, and other components, as the protonated organic acids have greater capacity to behave as solvents and/or hydrophobic/hydrophilic coupling agents (similar to hydrotropes). Finally, low pH compositions with lower levels of water provide surprisingly improved enzyme stability compared to equivalent compositions that have higher levels of water.

### Surfactant System

The cleaning compositions comprise a surfactant system in an amount sufficient to provide desired cleaning properties. In some aspects, the cleaning composition comprises, by weight of the composition, from about 20% to about 70% of a surfactant system. In some aspects, the cleaning composition comprises, by weight of the composition, from about 25% to about 60% of the surfactant system. In further aspects, the cleaning composition comprises, by weight of the composition, from about 30% to about 50% of the surfactant system. The surfactant system may comprise a detersive surfactant selected from anionic surfactants, nonionic surfactants, cationic surfactants, zwitterionic surfactants, amphoteric surfactants, ampholytic surfactants, or mixtures thereof. Those of ordinary skill in the art will understand that a detersive surfactant encompasses any surfactant or mixture of surfactants that provide cleaning, stain removing, or laundering benefit to soiled material.

In some aspects, the surfactant system of the cleaning composition comprises from about 1% to about 70%, by weight of the surfactant system, of one or more anionic surfactants. In certain aspects, the surfactant system of the cleaning composition comprises from about 2% to about 60%, by weight of the surfactant system, of one or more anionic surfactants. In further aspects, the surfactant system of the cleaning composition comprises from about 5% to about 30%, by weight of the surfactant system, of one or more anionic surfactants. In some aspects, the surfactant system may consist essentially of, or even consist of one or more anionic surfactants.

In some aspects, the surfactant system comprises a branched detersive surfactant, typically a branched anionic surfactant.

Branched Surfactants

Suitable branched detersive surfactants include anionic branched surfactants selected from branched sulphate or branched sulphonate surfactants, e.g., branched alkyl sulphate, branched alkyl alkoxylated sulphate, and branched alkyl benzene sulphonates, comprising one or more random alkyl branches, e.g., C₁₋₄ alkyl groups, typically methyl and/or ethyl groups.

In some aspects, the branched detersive surfactant is a mid-chain branched detersive surfactant, typically, a mid-chain branched anionic detersive surfactant, for example, a mid-chain branched alkyl sulphate and/or a mid-chain branched alkyl benzene sulphonate. In some aspects, the detersive surfactant is a mid-chain branched alkyl sulphate. In some aspects, the mid-chain branches are C₁₋₄ alkyl groups, typically methyl and/or ethyl groups.

In some aspects, the branched surfactant comprises a longer alkyl chain, mid-chain branched surfactant compound of the formula:

A_{b}-X-B

where:

(a) A_{b} is a hydrophobic C9 to C22 (total carbons in the moiety), typically from about C12 to about C18, mid-chain branched alkyl moiety having: (1) a longest linear carbon chain attached to the -X-B moiety in the range of from 8 to 21 carbon atoms; (2) one or more C1-C3 alkyl moieties branching from this longest linear carbon chain; (3) at least one of the branching alkyl moieties is attached directly to a carbon of the longest linear carbon chain at a position within the range of position 2 carbon (counting from carbon #1 which is attached to the -X-B moiety) to position ω-2 carbon (the terminal carbon minus 2 carbons, i.e., the third carbon from the end of the longest linear carbon chain); and (4) the surfactant composition has an average total number of carbon atoms in the A_{b}-X moiety in the above formula within the range of greater than 14.5 to about 17.5 (typically from about 15 to about 17);

b) B is a hydrophilic moiety selected from sulfates, sulfonates, amine oxides, polyoxyalkylene (such as polyoxyethylene and polyoxypropylene), alkoxylated sulfates, polyhydroxy moieties, phosphate esters, glycerol sulfonates, polygluconates, polyphosphate esters, phosphonates, sulfosuccinates, sulfosuccaminates, polyalkoxylated carboxylates, glucamides, taurinates, sarcosinates, glycinates, isethionates, dialkanolamides, monoalkanolamides, monoalkanolamide sulfates, diglycolamides, diglycolamide sulfates, glycerol esters, glycerol ester sulfates, glycerol ethers, glycerol ether sulfates, polyglycerol ethers, polyglycerol ether sulfates, sorbitan esters, polyalkoxylated sorbitan esters, ammonioalkanesulfonates, amidopropyl betaines, alkylated quats, alkylated/polyhydroxyalkylated quats, alkylated/polyhydroxylated oxypropyl quats, imidazolines, 2-yl-succinates, sulfonated alkyl esters, or sulfonated fatty acids (it is to be noted that more than one hydrophobic moiety may be attached to B, for example as in (A_{b}-X)_{z}-B to give dimethyl quats); and

(c) X is selected from —CH2- or —C(O)—.

Generally, in the above formula the A_{b} moiety does not have any quaternary substituted carbon atoms (i.e., 4 carbon atoms directly attached to one carbon atom). Depending on which hydrophilic moiety (B) is selected, the resultant surfactant may be anionic, nonionic, cationic, zwitterionic, amphoteric, or ampholytic. In some aspects, B is sulfate and the resultant surfactant is anionic.

In some aspects, the branched surfactant comprises a longer alkyl chain, mid-chain branched surfactant compound of the above formula wherein the A_{b} moiety is a branched primary alkyl moiety having the formula:

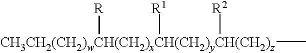

wherein the total number of carbon atoms in the branched primary alkyl moiety of this formula (including the R, R¹, and R² branching) is from 13 to 19; R, R1, and R2 are each independently selected from hydrogen and C1-C3 alkyl (typically methyl), provided R, R1, and R2 are not all hydrogen and, when z is 0, at least R or R1 is not hydrogen; w is an integer from 0 to 13; x is an integer from 0 to 13; y is an integer from 0 to 13; z is an integer from 0 to 13; and w+x+y+z is from 7 to 13.

In certain aspects, the branched surfactant comprises a longer alkyl chain, mid-chain branched surfactant compound of the above formula wherein the A_{b} moiety is a branched primary alkyl moiety having a formula selected from:

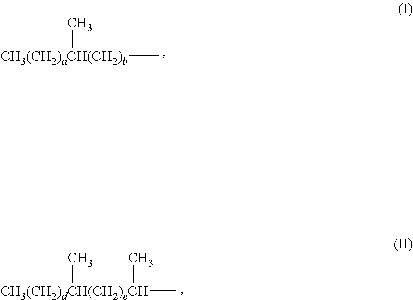

or mixtures thereof; wherein a, b, d, and e are integers, a+b is from 10 to 16, d+e is from 8 to 14 and wherein further
when a+b=10, a is an integer from 2 to 9 and b is an integer from 1 to 8;
when a+b=11, a is an integer from 2 to 10 and b is an integer from 1 to 9;
when a+b=12, a is an integer from 2 to 11 and b is an integer from 1 to 10;
when a+b=13, a is an integer from 2 to 12 and b is an integer from 1 to 11;
when a+b=14, a is an integer from 2 to 13 and b is an integer from 1 to 12;
when a+b=15, a is an integer from 2 to 14 and b is an integer from 1 to 13;
when a+b=16, a is an integer from 2 to 15 and b is an integer from 1 to 14;
when d+e=8, d is an integer from 2 to 7 and e is an integer from 1 to 6;
when d+e=9, d is an integer from 2 to 8 and e is an integer from 1 to 7;
when d+e=10, d is an integer from 2 to 9 and e is an integer from 1 to 8;
when d+e=11, d is an integer from 2 to 10 and e is an integer from 1 to 9;
when d+e=12, d is an integer from 2 to 11 and e is an integer from 1 to 10;
when d+e=13, d is an integer from 2 to 12 and e is an integer from 1 to 11;
when d+e=14, d is an integer from 2 to 13 and e is an integer from 1 to 12.

In the mid-chain branched surfactant compounds described above, certain points of branching (e.g., the location along the chain of the R, R¹, and/or R² moieties in the above formula) are preferred over other points of branching along the backbone of the surfactant. The formula below illustrates the mid-chain branching range (i.e., where points of branching occur), preferred mid-chain branching range, and more preferred mid-chain branching range for mono-methyl branched alkyl A^{b} moieties.

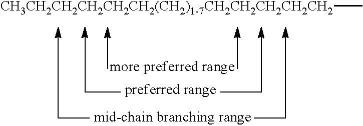

For mono-methyl substituted surfactants, these ranges exclude the two terminal carbon atoms of the chain and the carbon atom immediately adjacent to the -X-B group.

The formula below illustrates the mid-chain branching range, preferred mid-chain branching range, and more preferred mid-chain branching range for di-methyl substituted alkyl A^{b} moieties.

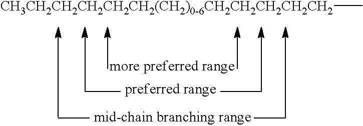

Additional suitable branched surfactants are disclosed in U.S. Pat. No. 6,008,181, U.S. Pat. No. 6,060,443, U.S. Pat. No. 6,020,303, U.S. Pat. No. 6,153,577, U.S. Pat. No. 6,093,856, U.S. Pat. No. 6,015,781, U.S. Pat. No. 6,133,222, U.S. Pat. No. 6,326,348, U.S. Pat. No. 6,482,789, U.S. Pat. No. 6,677,289, U.S. Pat. No. 6,903,059, U.S. Pat. No. 6,660,711, U.S. Pat. No. 6,335,312, and WO 9918929. Yet other suitable branched surfactants include those described in WO9738956, WO9738957, and WO0102451.

In some aspects, the branched anionic surfactant comprises a branched modified alkylbenzene sulfonate (MLAS), as discussed in WO 99/05243, WO 99/05242, WO 99/05244, WO 99/05082, WO 99/05084, WO 99/05241, WO 99/07656, WO 00/23549, and WO 00/23548.

In some aspects, the branched anionic surfactant comprises a C12/13 alcohol-based (alcohols such as Safol®, Marlipal®, available from Sasol) surfactant comprising a methyl branch randomly distributed along the hydrophobe chain.

Further suitable branched anionic detersive surfactants include surfactants derived from alcohols branched in the 2-alkyl position, such as the alcohols sold under the trade names Isalchem®123, Isalchem®125, Isalchem®145, Isalchem®167, which are derived from the oxo process. Due to the oxo process, the branching is situated in the 2-alkyl position. These 2-alkyl branched alcohols are typically in the range of C11 to C14/C15 in length and comprise structural isomers that are all branched in the 2-alkyl position. These branched alcohols and surfactants are described in US20110033413.

Other suitable branched surfactants include those disclosed in U.S. Pat. No. 6,037,313 (P&G), WO9521233 (P&G), U.S. Pat. No. 3,480,556 (Atlantic Richfield), U.S. Pat. No. 6,683,224 (Cognis), US20030225304A1 (Kao), US2004236158A1 (R&H), U.S. Pat. No. 6,818,700 (Atofina), US2004154640 (Smith et al), EP1280746 (Shell), EP1025839 (L'Oreal), U.S. Pat. No. 6,765,119 (BASF), EP1080084 (Dow), U.S. Pat. No. 6,723,867 (Cognis), EP1401792A1 (Shell), EP1401797A2 (Degussa AG), US2004048766 (Raths et al), U.S. Pat. No. 6,596,675 (L'Oreal), EP1136471 (Kao), EP961765 (Albemarle), U.S. Pat. No. 6,580,009 (BASF), US2003105352 (Dado et al), U.S. Pat. No. 6,573,345 (Cryovac), DE10155520 (BASF), U.S. Pat. No. 6,534,691 (du Pont), U.S. Pat. No. 6,407,279 (ExxonMobil), U.S. Pat. No. 5,831,134 (Peroxid-Chemie), U.S. Pat. No. 5,811,617 (Amoco), U.S. Pat. No. 5,463,143 (Shell), U.S. Pat. No. 5,304,675 (Mobil), U.S. Pat. No. 5,227,544 (BASF), U.S. Pat. No. 5,446,213A (MITSUBISHI KASEI CORPORATION), EP1230200A2 (BASF), EP1159237B1 (BASF), US20040006250A1 (NONE), EP1230200B1 (BASF), WO2004014826A1 (SHELL), US6703535B2 (CHEVRON), EP1140741B1 (BASF), WO2003095402A1 (OXENO), US6765106B2 (SHELL), US20040167355A1, U.S. Pat. No. 6,700,027B1 (CHEVRON), US20040242946A1 (NONE), WO2005037751A2 (SHELL), WO2005037752A1 (SHELL), U.S. Pat. No. 6,906,230B1 (BASF), WO2005037747A2 (SHELL) OIL COMPANY.

Additional suitable branched anionic detersive surfactants include surfactant derivatives of isoprenoid-based polybranched detergent alcohols, as described in U.S. Pat. No. 8,044,249, U.S. Pat. No. 7,994,369, U.S. Pat. No. 8,299,308, U.S. Pat. No. 8,232,432, and U.S. Pat. No. 8,232,431. Isoprenoid-based surfactants and isoprenoid derivatives are also described in the book entitled “Comprehensive Natural Products Chemistry: Isoprenoids Including Carotenoids and Steroids (Vol. two)”, Barton and Nakanishi, © 1999, Elsevier Science Ltd and are included in the structure E, and are hereby incorporated by reference.

Further suitable branched anionic detersive surfactants include those derived from anteiso and iso-alcohols. Such surfactants are disclosed in US2013/0053300A1.

Additional suitable branched anionic detersive surfactants include those described in US Patent Application Nos. 2011/0171155A1 and 2011/0166370A1.

Suitable branched anionic surfactants also include Guerbet-alcohol-based surfactants. Guerbet alcohols are branched, primary monofunctional alcohols that have two linear carbon chains with the branch point always at the second carbon position. Guerbet alcohols are chemically described as 2-alkyl-1-alkanols. Guerbet alcohols generally have from 12 carbon atoms to 36 carbon atoms. The Guerbet alcohols may be represented by the following formula: (R1)(R2)CHCH₂OH, where R1 is a linear alkyl group, R2 is a linear alkyl group, the sum of the carbon atoms in R1 and R2 is 10 to 34, and both R1 and R2 are present. Guerbet alcohols are commercially available from Sasol as Isofol® alcohols and from Cognis as Guerbetol®.

The surfactant system disclosed herein may comprise any of the branched surfactants described above individually or the surfactant system may comprise a mixture of the branched surfactants described above. Furthermore, each of the branched surfactants described above may include bio-based content (e.g., derived from a renewable resource or non-geologically derived, where geologically derived means derived from, for example, petrochemicals, natural gas, or coal; geologically derived materials cannot be easily replenished or regrown, in contrast to plant- or algae-produced oils). In some aspects, the branched surfactant has a bio-based content of at least about 50%, at least about 60%, at least about 70%, at least about 80%, at least about 90%, at least about 95%, at least about 97%, or about 100%.

Linear Anionic Surfactants

The surfactant system of the cleaning composition may comprise a saturated or unsaturated, substituted or unsubstituted, linear anionic surfactant. Linear surfactants may be derived from natural triglycerides, linear alpha olefins, e.g., alpha-olefin sulfonate (AOS), or other materials. Suitable linear anionic detersive surfactants include linear sulphate and linear sulphonate surfactants.

Suitable linear sulphonate detersive surfactants include alkyl benzene sulphonate, in one aspect, C10-13 alkyl benzene sulphonate. Suitable alkyl benzene sulphonate (LAS) may be obtained, by sulphonating commercially available linear alkyl benzene (LAB); suitable LAB includes low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. A suitable linear anionic detersive surfactant is alkyl benzene sulphonate that is obtained by DETAL catalyzed process, although other synthesis routes, such as HF, may also be suitable. In one aspect a magnesium salt of LAS is used.

Suitable linear sulphate detersive surfactants include alkyl sulphate, in one aspect, C8-18 alkyl sulphate, or predominantly C12 alkyl sulphate.

Another suitable linear sulphate detersive surfactant is alkyl alkoxylated sulphate, in one aspect, alkyl ethoxylated sulphate, in one aspect, a C8-18 alkyl alkoxylated sulphate, in another aspect, a C8-18 alkyl ethoxylated sulphate, typically the alkyl alkoxylated sulphate has an average degree of alkoxylation of from 0.5 to 20, or from 0.5 to 10, typically the alkyl alkoxylated sulphate is a C8-18 alkyl ethoxylated sulphate having an average degree of ethoxylation of from 0.5 to 10, from 0.5 to 7, from 0.5 to 5 or even from 0.5 to 3.

Other linear anionic surfactants useful herein are the water-soluble salts of: paraffin sulfonates and secondary alkane sulfonates containing from about 8 to about 24 (and in some examples about 12 to 18) carbon atoms; alkyl glyceryl ether sulfonates, especially those ethers of C₈₋₁₈ alcohols (e.g., those derived from tallow and coconut oil). Mixtures of the alkylbenzene sulfonates with the above-described paraffin sulfonates, secondary alkane sulfonates and alkyl glyceryl ether sulfonates are also useful. Further suitable anionic surfactants useful herein may be found in U.S. Pat. No. 4,285,841, Barrat et al., issued Aug. 25, 1981, and in U.S. Pat. No. 3,919,678, Laughlin, et al., issued Dec. 30, 1975, both of which are herein incorporated by reference. Another suitable class of linear anionic surfactants is methyl ester sulfonates.

Nonionic Surfactant

The surfactant system of the cleaning composition may comprise a nonionic surfactant. In some examples, the surfactant system comprises up to about 25%, by weight of the surfactant system, of one or more nonionic surfactants, e.g., as a co-surfactant. In some examples, the cleaning compositions comprises from about 0.1% to about 15%, by weight of the surfactant system, of one or more nonionic surfactants. In further examples, the cleaning compositions comprises from about 0.3% to about 10%, by weight of the surfactant system, of one or more nonionic surfactants. In further examples, the cleaning compositions comprise from about 0.15% to about 5%, by weight of the surfactant system, of one or more nonionic surfactants.

Suitable nonionic surfactants useful herein can comprise any conventional nonionic surfactant. These can include, for e.g., alkoxylated fatty alcohols and amine oxide surfactants. In some examples, the cleaning compositions may contain an ethoxylated nonionic surfactant. These materials are described in U.S. Pat. No. 4,285,841, Barrat et al, issued Aug. 25, 1981. The nonionic surfactant may be selected from the ethoxylated alcohols and ethoxylated alkyl phenols of the formula R(OC₂H₄)ₙOH, wherein R is selected from the group consisting of aliphatic hydrocarbon radicals containing from about 8 to about 15 carbon atoms and alkyl phenyl radicals in which the alkyl groups contain from about 8 to about 12 carbon atoms, and the average value of n is from about 5 to about 15. These surfactants are more fully described in U.S. Pat. No. 4,284,532, Leikhim et al, issued Aug. 18, 1981. In one example, the nonionic surfactant is selected from ethoxylated alcohols having an average of about 24 carbon atoms in the alcohol and an average degree of ethoxylation of about 9 moles of ethylene oxide per mole of alcohol.

Other non-limiting examples of nonionic surfactants useful herein include: C₁₂-C₁₈ alkyl ethoxylates, such as, NEODOL® nonionic surfactants from Shell; C₆-C₁₂ alkyl phenol alkoxylates wherein the alkoxylate units are a mixture of ethyleneoxy and propyleneoxy units; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols, BA, as discussed in U.S. Pat. No. 6,150,322; C₁₄-C₂₂ mid-chain branched alkyl alkoxylates, BAEₓ, wherein x is from 1 to 30, as discussed in U.S. Pat. No. 6,153,577, U.S. Pat. No. 6,020,303 and U.S. Pat. No. 6,093,856; Alkylpolysaccharides as discussed in U.S. Pat. No. 4,565,647 to Llenado, issued Jan. 26, 1986; specifically alkylpolyglycosides as discussed in U.S. Pat. No. 4,483,780 and U.S. Pat. No. 4,483,779; Polyhydroxy fatty acid amides as discussed in U.S. Pat. No. 5,332,528, WO 92/06162, WO 93/19146, WO 93/19038, and WO 94/09099; and ether capped poly(oxyalkylated) alcohol surfactants as discussed in U.S. Pat. No. 6,482,994 and WO 01/42408.

Anionic/Nonionic Combinations

The surfactant system may comprise a combination of anionic and nonionic surfactant materials. In some examples, the weight ratio of anionic surfactant to nonionic surfactant is at least about 2:1. In other examples, the weight ratio of anionic surfactant to nonionic surfactant is at least about 3:1 or at least about 5:1. In further examples, the weight ratio of anionic surfactant to nonionic surfactant is at least about 10:1. In some aspects, the weight ratio of anionic surfactant to nonionic surfactant is from about 3:1 to about 15:1.

Cationic Surfactants

The surfactant system may comprise a cationic surfactant. In some aspects, the surfactant system comprises from about 0% to about 7%, or from about 0.1% to about 5%, or from about 1% to about 4%, by weight of the surfactant system, of a cationic surfactant, e.g., as a co-surfactant. In some aspects, the cleaning compositions of the invention are substantially free of cationic surfactants and surfactants that become cationic below a pH of 7 or below a pH of 6.

Non-limiting examples of cationic surfactants include: the quaternary ammonium surfactants, which can have up to 26 carbon atoms include: alkoxylate quaternary ammonium (AQA) surfactants as discussed in U.S. Pat. No. 6,136,769; dimethyl hydroxyethyl quaternary ammonium as discussed in U.S. Pat. No. 6,004,922; dimethyl hydroxyethyl lauryl ammonium chloride; polyamine cationic surfactants as discussed in WO 98/35002, WO 98/35003, WO 98/35004, WO 98/35005, and WO 98/35006; cationic ester surfactants as discussed in U.S. Pat. Nos. 4,228,042, 4,239,660 4,260,529 and U.S. Pat. No. 6,022,844; and amino surfactants as discussed in U.S. Pat. No. 6,221,825 and WO 00/47708, specifically amido propyldimethyl amine (APA).

Zwitterionic Surfactants

Examples of zwitterionic surfactants include: derivatives of secondary and tertiary amines, derivatives of heterocyclic secondary and tertiary amines, or derivatives of quaternary ammonium, quaternary phosphonium or tertiary sulfonium compounds. See U.S. Pat. No. 3,929,678 at column 19, line 38 through column 22, line 48, for examples of zwitterionic surfactants; betaines, including alkyl dimethyl betaine and cocodimethyl amidopropyl betaine, C₈ to C₁₈ (for example from C₁₂ to C₁₈) amine oxides and sulfo and hydroxy betaines, such as N-alkyl-N,N-dimethylammino-1-propane sulfonate where the alkyl group can be C₈ to C₁₈ and in certain embodiments from C₁₀ to C₁₄.

Ampholytic Surfactants

Specific, non-limiting examples of ampholytic surfactants include: aliphatic derivatives of secondary or tertiary amines, or aliphatic derivatives of heterocyclic secondary and tertiary amines in which the aliphatic radical can be straight- or branched-chain. One of the aliphatic substituents may contain at least about 8 carbon atoms, for example from about 8 to about 18 carbon atoms, and at least one contains an anionic water-solubilizing group, e.g. carboxy, sulfonate, sulfate. See U.S. Pat. No. 3,929,678 at column 19, lines 18-35, for suitable examples of ampholytic surfactants.

Amphoteric Surfactants

Examples of amphoteric surfactants include: aliphatic derivatives of secondary or tertiary amines, or aliphatic derivatives of heterocyclic secondary and tertiary amines in which the aliphatic radical can be straight- or branched-chain. One of the aliphatic substituents contains at least about 8 carbon atoms, typically from about 8 to about 18 carbon atoms, and at least one contains an anionic water-solubilizing group, e.g. carboxy, sulfonate, sulfate. Examples of compounds falling within this definition are sodium 3-(dodecylamino)propionate, sodium 3-(dodecylamino) propane-1-sulfonate, sodium 2-(dodecylamino)ethyl sulfate, sodium 2-(dimethylamino) octadecanoate, disodium 3-(N-carboxymethyldodecylamino)propane 1-sulfonate, disodium octadecyl-imminodiacetate, sodium 1-carboxymethyl-2-undecylimidazole, and sodium N,N-bis(2-hydroxyethyl)-2-sulfato-3-dodecoxypropylamine. See U.S. Pat. No. 3,929,678 to Laughlin et al., issued Dec. 30, 1975 at column 19, lines 18-35, for examples of amphoteric surfactants.

In some aspects, the surfactant system comprises an anionic surfactant and, as a co-surfactant, a nonionic surfactant, for example, a C₁₂-C₁₈ alkyl ethoxylate. In another aspect, the surfactant system comprises C₁₀-C₁₅ alkyl benzene sulfonates (LAS) and, as a co-surfactant, an anionic surfactant, e.g., C₁₀-C₁₈ alkyl alkoxy sulfates (AEₓS), where x is from 1-30. In another aspect, the surfactant system comprises an anionic surfactant and, as a co-surfactant, a cationic surfactant, for example, dimethyl hydroxyethyl lauryl ammonium chloride.

Adjunct Cleaning Additives

The cleaning compositions of the invention may also contain adjunct cleaning additives. The adjunct cleaning additives may be selected from soaps, builders, solvents, fabric enhancement polymers, clay soil removal/anti-redeposition agents, polymeric soil release agents, polymeric dispersing agents, polymeric grease cleaning agents, brightener, dye transfer inhibitor, chelants, polyacrylate polymers, colorant dye, hueing dyes, perfumes, processing aids, bleaching additives, bleach activators, bleach precursors, bleach catalysts, co-solvents, hydrotropes, liquid carrier, phase stabilizers, enzyme stabilizers, enzymes, soil suspending agents, deflocculating polymers, bactericides, fungicides, UV absorbers, anti-yellowing agents, anti-oxidants, optical brighteners, suds suppressors, opacifiers, suds boosters, anticorrosion agents, radical scavengers, chlorine scavengers, structurants, fabric softening additives, other fabric care benefit agents, pH adjusting agents, fluorescent whitening agents, smectite clays, structuring agents, preservatives, thickeners, coloring agents, fabric softening additives, rheology modifiers, fillers, germicides or mixtures thereof. A detailed description of additional components can be found in U.S. Pat. No. 6,020,303. The list of adjuncts herein is not intended to be exhaustive and other unlisted adjuncts well known in the art, may also be included in the composition.

Soap—

Soap includes fatty acids and soluble salts thereof. Fatty acids and/or soaps or their derivatives are known to possess multiple functionalities in detergents, acting as surfactants, builders, thickeners, foam suppressors etc. Soaps are commonly neutralized or partially neutralized in situ in the formulation using neutralizers such as sodium hydroxide, potassium hydroxide and/or alkanolamines, such as MEA. Any soluble soap or fatty acid is suitable for use herein, including, lauric, myristic, palmitic stearic, oleic, linoleic, linolenic acid, and mixtures thereof. Naturally obtainable fatty acids, which are usually complex mixtures, are also suitable (such as tallow, coconut, and palm kernel fatty acids).

Builder—

Examples of suitable builders which may be used include water-soluble alkali metal phosphates, polyphosphates, borates, silicates and also carbonates; water-soluble amino polycarboxylates; water-soluble salts of phytic acid; polycarboxylates; zeolites or aluminosilicates and combinations thereof. Specific examples of these are: sodium and potassium triphosphates, pyrophosphates, orthophosphates, hexametaphosphates, tetraborates, silicates, and carbonates; water-soluble salts of mellitic acid, citric acid, and carboxymethyloxysuccinic acid, salts of polymers of itaconic acid and maleic acid, tartrate monosuccinate, tartrate disuccinate.

Organic Solvent—

In some aspects, the cleaning compositions comprise organic solvent. The compositions may comprise from about 0.05% to about 25%, or from about 0.1% to about 15%, or from about 1% to about 10%, or from about 2% to about 5%, by weight of the composition organic solvent. The composition may comprise less than about 5%, or less than about 1%, organic solvent. In other aspects, the compositions are substantially free of organic solvent.

The organic solvent, if present, may be selected from 1,2-propanediol, methanol, ethanol, glycerol, dipropylene glycol, diethylene glycol (DEG), methyl propanediol, or mixtures thereof. Other lower alcohols, such C1-C4 alkanolamines, e.g., monoethanolamine and/or triethanolamine, may also be used. In some aspects, the organic solvent comprises propanediol or diethylene glycol (DEG).

Fabric Enhancement Polymers—

Fabric enhancement polymers may optionally be included in the cleaning compositions disclosed herein to, for example, aid in the deposition of certain actives, e.g., fabric softening actives. Suitable fabric enhancement polymers are typically cationically charged and/or have a high molecular weight. Suitable concentrations of this component are in the range of from about 0.01% to about 50%, or from about 0.1% to 15%, or from about 0.2% to about 5.0%, or from about 0.5% to about 3.0% by weight of the composition. The fabric enhancement polymers may be a homopolymer or be formed from two or more types of monomers. The monomer weight of the polymer will generally be between 5,000 and 10,000,000, typically at least 10,000 and preferably in the range 100,000 to 2,000,000. Typical fabric enhancement polymers will have cationic charge densities of at least about 0.2 meq/gm, or at least about 0.25 meq/gm, more typically at least about 0.3 meq/gm, but also typically less than about 5 meq/gm, or less than about 3 meq/gm, or less than about 2 meq/gm at the pH of intended use of the composition, which pH will generally range from pH 2 to pH 7. The fabric enhancement polymers may be of natural or synthetic origin.

Suitable fabric enhancement polymers are selected from substituted or unsubstituted polyquaternary ammonium compounds, cationically modified polysaccharides, cationically modified (meth)acrylamide polymers/copolymers, cationically modified (meth)acrylate polymers/copolymers, chitosan, quaternized vinylimidazole polymers/copolymers, dimethyldiallylammonium polymers/copolymers, polyethylene imine based polymers, cationic guar gums, and derivatives thereof, or combinations thereof.

Other suitable fabric enhancement polymers include, for example: a) copolymers of 1-vinyl-2-pyrrolidine and 1-vinyl-3-methyl-imidazolium salt (e.g. chloride alt), referred to in the industry by the Cosmetic, Toiletry, and Fragrance Association, (CTFA) as Polyquaternium-16; b) copolymers of 1-vinyl-2-pyrrolidine and dimethylaminoethyl methacrylate, referred to in the industry (CTFA) as Polyquaternium-11; c) cationic diallyl quaternary ammonium-containing polymers including, for example, dimethyldiallylammonium chloride homopolymer and copolymers of acrylamide and dimethyldiallylammonium chloride, referred to in the industry (CTFA) as Polyquaternium 6 and Polyquaternium 7, respectively; d) mineral acid salts of amino-alkyl esters of homo- and copolymers of unsaturated carboxylic acids having from 3 to 5 carbon atoms as describes in U.S. Pat. No. 4,009,256; e) amphoteric copolymers of acrylic acid including copolymers of acrylic acid and dimethyldiallylammonium chloride (referred to in the industry by CTFA as Polyquaternium 22), terpolymers of acrylic acid with dimethyldiallylammonium chloride and acrylamide (referred to in the industry by CTFA as Polyquaternium 39), and terpolymers of acrylic acid with methacrylamidopropyl trimethylammonium chloride and methylacrylate (referred to in the industry by CTFA as Polyquaternium 47). Further suitable fabric enhancement polymers include cationic polysaccharide polymers, such as cationic cellulose and derivatives thereof, cationic starch and derivatives thereof, and cationic guar gums and derivatives thereof. Other suitable cationic polysaccharide polymers include quaternary nitrogen-containing cellulose ethers and a cationic guar gum derivative.

Clay Soil Removal/Anti-Redeposition Agents—

The compositions of the present invention may also optionally contain water-soluble ethoxylated amines having clay soil removal and antiredeposition properties. The compositions typically contain from about 0.01% to about 5%, by weight of the composition, of these agents.

Exemplary clay soil removal and antiredeposition agents are described in U.S. Pat. Nos. 4,597,898; 548,744; 4,891,160; European Patent Application Nos. 111,965; 111,984; 112,592; and WO 95/32272.

Polymeric Soil Release Agent—

Polymeric soil release agents, hereinafter “SRA”, may be employed in the present detergent compositions. If utilized, the compositions will generally comprise from about 0.01% to about 10.0%, or from about 0.1% to about 5%, or from about 0.2% to about 3.0%, by weight of the composition, of SRA. Suitable SRAs typically have hydrophilic segments to hydrophilize the surface of hydrophobic fibers, such as polyester and nylon, and hydrophobic segments to deposit upon hydrophobic fibers and remain adhered thereto through completion of washing and rinsing cycles, thereby serving as an anchor for the hydrophilic segments. This can enable stains occurring subsequent to treatment with SRA to be more easily cleaned in later washing procedures.

SRAs include, for example, a variety of charged, e.g., anionic or even cationic (see U.S. Pat. No. 4,956,447), as well as noncharged monomer units and structures may be linear, branched, or even star-shaped. They may include capping moieties which are especially effective in controlling molecular weight or altering the physical or surface-active properties. Structures and charge distributions may be tailored for application to different fiber or textile types and for varied detergent or detergent additive products. SRAs are described in U.S. Pat. Nos. 4,968,451; 4,711,730; 4,721,580; 4,702,857; 4,877,896; 3,959,230; 3,893,929; 4,000,093; 5,415,807; 4,201,824; 4,240,918; 4,525,524; 4,201,824; 4,579,681; 4,787,989; WO2012/104156/57/58; and WO2012/104159. Specific examples of SRAs include Texcare® SRN 300 and Texcare® SRN 400, from Clariant.

Polymeric Dispersing Agents—

Polymeric dispersing agents may be utilized at levels of from about 0.1% to about 7%, by weight, in the compositions herein. Suitable polymeric dispersing agents include polymeric polycarboxylates and polyethylene glycols, although others known in the art can also be used. For example, a wide variety of modified or unmodified polyacrylates, polyacrylate/mealeates, or polyacrylate/methacrylates are useful. Examples of polymeric dispersing agents are found in U.S. Pat. No. 3,308,067.

Alkoxylated Polyamine Polymers—

Soil suspension, grease cleaning, and particulate cleaning polymers may include the alkoxylated polyamines Such materials include but are not limited to ethoxylated polyethyleneimine, ethoxylated hexamethylene diamine, and sulfated versions thereof. Polypropoxylated derivatives are also included. A wide variety of amines and polyaklyeneimines can be alkoxylated to various degrees, and optionally further modified to provide the abovementioned benefits. A useful example is 600 g/mol polyethyleneimine core ethoxylated to 20 EO groups per NH and is available from BASF.

Modified Hexamethylenediamine—

The composition may comprise a modified hexamentylenediamine. The modification of the hexamentylenediamine includes: (1) one or two alkoxylation modifications per nitrogen atom of the hexamentylenediamine. The alkoxylation modification consisting of the replacement of a hydrogen atom on the nitrogen of the hexamentylenediameine by a (poly)alkoxylene chain having an average of about 1 to about 40 alkoxy moieties per modification, wherein the terminal alkoxy moiety of the alkoxylene chain is capped with hydrogen, a C1-C4 alkyl, sulfates, carbonates, or mixtures thereof; (2) a substitution of one C1-C4 alkyl moiety and one or two alkoxylation modifications per nitrogen atom of the hexamentylenediamine. The alkoxylation modification consisting of the replacement of a hydrogen atom by a (poly)alkoxylene chain having an average of about 1 to about 40 alkoxy moieties per modification wherein the terminal alkoxy moiety of the alkoxylene chain is capped with hydrogen, a C1-C4 alkyl or mixtures thereof; or (3) a combination thereof. The alkoxylation may be in the form of ethoxy, propoxy, butoxy or a mixture thereof. U.S. Pat. No. 4,597,898 Vander Meer, issued Jul. 1, 1986,

A preferred modified hexamethylenediamine has the general structure below:

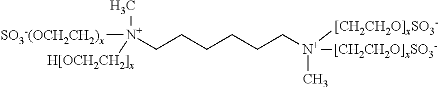

wherein x is from about 20 to about 30 and approximately 40% of the (poly)alkoxylene chain terminal alkoxy moieties are sulfonated.

A illustrative modified hexamethylenediamine has the general structure below:

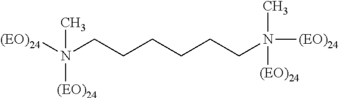

available under the tradename LUTENSIT® from BASF and such as those described in WO 01/05874.

Polymeric Grease Cleaning Polymers—

Alkoxylated polycarboxylates such as those prepared from polyacrylates are useful herein to provide additional grease removal performance. Such materials are described in WO 91/08281 and PCT 90/01815. Chemically, these materials comprise polyacrylates having one ethoxy side-chain per every 7-8 acrylate units. The side-chains are of the formula —(CH2CH2O)m (CH2)nCH3 wherein m is 2-3 and n is 6-12. The side-chains are ester-linked to the polyacrylate “backbone” to provide a “comb” polymer type structure. The molecular weight can vary, but is typically in the range of about 2000 to about 50,000. Such alkoxylated polycarboxylates can comprise from about 0.05% to about 10%, by weight, of the compositions herein.

The compositions disclosed herein may also comprise amphiphilic graft co-polymers. In some aspects, the amphiphilic graft co-polymer comprises (i) a polyethyelene glycol backbone; and (ii) and at least one pendant moiety selected from polyvinyl acetate, polyvinyl alcohol and mixtures thereof. A preferred amphiphilic graft co-polymer is Sokalan HP22, supplied from BASF. Further examples of suitable amphiphilic graft co-polymers are described in U.S. Pat. No. 8,143,209.

Chelating Agents—

The compositions herein may also contain one or more iron and/or manganese and/or other metal ion chelating agents. Such chelating agents can be selected from the group consisting of amino carboxylates, amino phosphonates, polyfunctionally-substituted aromatic chelating agents and mixtures therein. The chelating agent may be present in the detergent compositions of the present invention at from about 0.2% to about 0.7% or from about 0.3% to about 0.6% by weight of the detergent composition.

Non-limiting examples of chelants of use in the present invention are found in U.S. Pat. Nos. 7,445,644, 7,585,376 and 2009/0176684A1. Useful chelants include heavy metal chelating agents, such as diethylenetriaminepentaacetic acid (DTPA) and/or a catechol, e.g., Tiron. Other chelating agents suitable for use herein can be selected from the group consisting of aminocarboxylates, aminophosphonates, polyfunctionally-substituted aromatic chelating agents and mixtures thereof. Chelants of use include, but are not limited to: HEDP (hydroxyethanedimethylenephosphonic acid); MGDA (methylglycinediacetic acid); ethylenediamine disuccinate (EDDS); or mixtures thereof.

Enzymes—

Suitable levels of enzymes in the compositions disclosed herein are from about 0.001% to about 5% by weight of the cleaning composition. Suitable enzymes include proteases, amylases, cellulases, lipases, xylogucanases, pectate lyases, mannanases, bleaching enzymes, cutinases, and mixtures thereof.

For the enzymes, accession numbers or IDs shown in parentheses refer to the entry numbers in the databases Genbank, EMBL and Swiss-Prot. For any mutations standard 1-letter amino acid codes are used with a * representing a deletion. Accession numbers prefixed with DSM refer to microorganisms deposited at Deutsche Sammlung von Mikroorganismen and Zellkulturen GmbH, Mascheroder Weg 1b, 38124 Brunswick (DSMZ).

Protease.

The composition may comprise a protease. Suitable proteases include metalloproteases and/or serine proteases, including neutral or alkaline microbial serine proteases, such as subtilisins (EC 3.4.21.62). Suitable proteases include those of animal, vegetable or microbial origin. In one aspect, such suitable protease may be of microbial origin. The suitable proteases include chemically or genetically modified mutants of the aforementioned suitable proteases. In one aspect, the suitable protease may be a serine protease, such as an alkaline microbial protease or/and a trypsin-type protease. Examples of suitable neutral or alkaline proteases include:

(a) subtilisins (EC 3.4.21.62), including those derived from Bacillus, such as Bacillus lentus, Bacillus alkalophilus (P27963, ELYA_BACAO), Bacillus subtilis, Bacillus amyloliquefaciens (P00782, SUBT_BACAM), Bacillus pumilus (P07518) and Bacillus gibsonii(DSM14391).

(b) trypsin-type or chymotrypsin-type proteases, such as trypsin (e.g. of porcine or bovine origin), including the Fusarium protease and the chymotrypsin proteases derived from Cellumonas (A2RQE2).

(c) metalloproteases, including those derived from Bacillus amyloliquefaciens (P06832, NPRE_BACAM).

Preferred proteases include those derived from Bacillus gibsonii or Bacillus Lentus such as subtilisin 309 (P29600) and/or DSM 5483 (P29599).

Suitable commercially available protease enzymes include: those sold under the trade names Alcalase®, Savinase®, Primase®, Durazym®, Polarzyme®, Kannase®, Liquanase®, Liquanase Ultra®, Savinase Ultra®, Ovozyme®, Neutrase®, Everlase® and Esperase® by Novozymes A/S (Denmark); those sold under the tradename Maxatase®, Maxacal®, Maxapem®, Properase®, Purafect®, Purafect Prime®, Purafect Ox®, FN3®, FN4®, Excellase® and Purafect OXP® by Genencor International; those sold under the tradename Opticlean® and Optimase® by Solvay Enzymes; those available from Henkel/Kemira, namely BLAP (P29599 having the following mutations S99D+S101 R+S103A+V104I+G159S), and variants thereof including BLAP R (BLAP with S3T+V4I+V199M+V2051+L217D), BLAP X (BLAP with S3T+V4I+V2051) and BLAP F49 (BLAP with S3T+V4I+A194P+V199M+V2051+L217D) all from Henkel/Kemira; and KAP (Bacillus alkalophilus subtilisin with mutations A230V+S256G+S259N) from Kao.

Amylase:

Suitable amylases are alpha-amylases, including those of bacterial or fungal origin. Chemically or genetically modified mutants (variants) are included. A preferred alkaline alpha-amylase is derived from a strain of Bacillus, such as Bacillus licheniformis, Bacillus amyloliquefaciens, Bacillus stearothermophilus, Bacillus subtilis, or other Bacillus sp., such as Bacillus sp. NCIB 12289, NCIB 12512, NCIB 12513, sp 707, DSM 9375, DSM 12368, DSMZ no. 12649, KSM AP1378, KSM K36 or KSM K38. Preferred amylases include:

(a) alpha-amylase derived from Bacillus licheniformis (P06278, AMY_BACLI), and variants thereof, especially the variants with substitutions in one or more of the following positions: 15, 23, 105, 106, 124, 128, 133, 154, 156, 181, 188, 190, 197, 202, 208, 209, 243, 264, 304, 305, 391, 408, and 444.

(b) AA560 amylase (CBU30457, HD066534) and variants thereof, especially the variants with one or more substitutions in the following positions: 26, 30, 33, 82, 37, 106, 118, 128, 133, 149, 150, 160, 178, 182, 186, 193, 203, 214, 231, 256, 257, 258, 269, 270, 272, 283, 295, 296, 298, 299, 303, 304, 305, 311, 314, 315, 318, 319, 339, 345, 361, 378, 383, 419, 421, 437, 441, 444, 445, 446, 447, 450, 461, 471, 482, 484, preferably that also contain the deletions of D183* and G184*.

(c) variants exhibiting at least 90% identity with the wild-type enzyme from Bacillus SP722 (CBU30453, HD066526), especially variants with deletions in the 183 and 184 positions.

Suitable commercially available alpha-amylases are Duramyl®, Liquezyme® Termamyl®, Termamyl Ultra®, Natalase®, Supramyl®, Stainzyme®, Stainzyme Plus®, Fungamyl® and BAN® (Novozymes A/S), Bioamylase® and variants thereof (Biocon India Ltd.), Kemzym® AT 9000 (Biozym Ges. m.b.H, Austria), Rapidase®, Purastar®, Optisize HT Plus®, Enzysize®, Powerase® and Purastar Oxam®, Maxamyl® (Genencor International Inc.) and KAM® (KAO, Japan). Preferred amylases are Natalase®, Stainzyme® and Stainzyme Plus®.

Cellulase:

The composition may comprise a cellulase. Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum.

Commercially available cellulases include Celluzyme®, and Carezyme® (Novozymes A/S), Clazinase®, and Puradax HA® (Genencor International Inc.), and KAC-500(B)® (Kao Corporation).

In one aspect, the cellulase can include microbial-derived endoglucanases exhibiting endo-beta-1,4-glucanase activity (E.C. 3.2.1.4), including a bacterial polypeptide endogenous to a member of the genus Bacillus which has a sequence of at least 90%, 94%, 97% and even 99% identity to the amino acid sequence SEQ ID NO:2 in U.S. Pat. No. 7,141,403) and mixtures thereof. Suitable endoglucanases are sold under the tradenames Celluclean® and Whitezyme® (Novozymes A/S, Bagsvaerd, Denmark).

Preferably, the composition comprises a cleaning cellulase belonging to Glycosyl Hydrolase family 45 having a molecular weight of from 17 kDa to 30 kDa, for example the endoglucanases sold under the tradename Biotouch® NCD, DCC and DCL (AB Enzymes, Darmstadt, Germany).

Highly preferred cellulases also exhibit xyloglucanase activity, such as Whitezyme®.

Lipase.

The composition may comprise a lipase. Suitable lipases include those of bacterial or fungal origin. Chemically modified or protein engineered mutants are included. Examples of useful lipases include lipases from Humicola(synonym Thermomyces), e.g., from H. lanuginosa (T lanuginosus), or from H. insolens, a Pseudomonas lipase, e.g., from P. alcaligenes or P. pseudoalcaligenes, P. cepacia, P. stutzeri, P. fluorescens, Pseudomonas sp. strain SD 705, P. wisconsinensis, a Bacillus lipase, e.g., from B. subtilis, B. stearothermophilus or B. pumilus.

The lipase may be a “first cycle lipase”, preferably a variant of the wild-type lipase from Thermomyces lanuginosus comprising T231R and N233R mutations. The wild-type sequence is the 269 amino acids (amino acids 23-291) of the Swissprot accession number Swiss-Prot O59952 (derived from Thermomyces lanuginosus(Humicola lanuginosa)). Preferred lipases would include those sold under the tradenames Lipex®, Lipolex® and Lipoclean® by Novozymes, Bagsvaerd, Denmark.

Preferably, the composition comprises a variant of Thermomyces lanuginosa(O59952) lipase having >90% identity with the wild type amino acid and comprising substitution(s) at T231 and/or N233, preferably T231R and/or N233R.

In another aspect, the composition comprises a variant of Thermomyces lanuginosa(O59952) lipase having >90% identity with the wild type amino acid and comprising substitution(s):

(a) S58A+V60S+I83T+A150G+L227G+T231R+N233R+I255A+P256K;

(b) S58A+V60S+I86V+A150G+L227G+T231R+N233R+I255A+P256K;

(c) S58A+V60S+I86V+T143S+A150G+L227G+T231R+N233R+I255A+P256K;

(d) S58A+V60S+I86V+T143S+A150G+G163K+S216P+L227G+T231R+N233R+I255A+P256K;

(e) E1*+S58A+V60S+I86V+T143S+A150G+L227G+T231R+N233R+I255A+P256K;

(f) S58A+V60S+I86V+K98I+E99K+T143S+A150G+L227G+T231R+N233R+I255A+P256K;

(g) E1N+S58A+V60S+I86V+K98I+E99K+T143S+A150G+L227G+T231R+N233R+I255A+P256K+L259F;

(h) S58A+V60S+I86V+K98I+E99K+D102A+T143S+A150G+L227G+T231R+N233R+I255A+P256K;

(i) N33Q+S58A+V60S+I86V+T143S+A150G+L227G+T231R+N233R+I255A+P256K;

(j) E1*+S58A+V60S+I86V+K98I+E99K+T143S+A150G+L227G+T231R+N233R+I255A+P256K;

(k) E1N+S58A+V60S+I86V+I081+E99K+T143S+A150G+S216P+L227G+T231R+N233R+I255A+P256K;

(l) D27N+S58A+V60S+I86V+G91N+N94R+D1 U N+T143S+A150G+L227G+T231R+N233R+I255A+P256K;

(m) E1N+S58A+V60S+I86V+K98I+E99K+T143S+A150G+E210A+S216P+L227G+T231R+N233R+I255A+P256K;

(n) A150G+E210V+T231R+N233R+I255A+P256K; and

(o) I202L+E210G+T231R+N233R+I255A+P256K.

Xyloglucanase:

Suitable xyloglucanase enzymes have enzymatic activity towards both xyloglucan and amorphous cellulose substrates, wherein the enzyme is a glycosyl hydrolase (GH) is selected from GH families 5, 12, 44 or 74. Preferably, the glycosyl hydrolase is selected from GH family 44. Suitable glycosyl hydrolases from GH family 44 are the XYG1006 glycosyl hydrolase from Paenibacillus polyxyma (ATCC 832) and variants thereof.

Pectate Lyase:

Suitable pectate lyases are either wild-types or variants of Bacillus-derived pectate lyases (CAF05441, AAU25568) sold under the tradenames Pectawash®, Pectaway® and X-Pect® (from Novozymes A/S, Bagsvaerd, Denmark).

Mannanase:

Suitable mannanases are sold under the tradenames Mannaway® (from Novozymes A/S, Bagsvaerd, Denmark), and Purabrite® (Genencor International Inc., Palo Alto, Calif.).

Bleaching Enzyme:

Suitable bleach enzymes include oxidoreductases, for example oxidases such as glucose, choline or carbohydrate oxidases, oxygenases, catalases, peroxidases, like halo-, chloro-, bromo-, lignin-, glucose- or manganese-peroxidases, dioxygenases or laccases (phenoloxidases, polyphenoloxidases). Suitable commercial products are sold under the Guardzyme® and Denilite® ranges from Novozymes. Advantageously, additional, preferably organic, particularly preferably aromatic compounds are incorporated with the bleaching enzyme; these compounds interact with the bleaching enzyme to enhance the activity of the oxidoreductase (enhancer) or to facilitate the electron flow (mediator) between the oxidizing enzyme and the stain typically over strongly different redox potentials.

Other suitable bleaching enzymes include perhydrolases, which catalyse the formation of peracids from an ester substrate and peroxygen source. Suitable perhydrolases include variants of the Mycobacterium smegmatis perhydrolase, variants of so-called CE-7 perhydrolases, and variants of wild-type subtilisin Carlsberg possessing perhydrolase activity.

Cutinase:

Suitable cutinases are defined by E.C. Class 3.1.1.73, preferably displaying at least 90%, or 95%, or most preferably at least 98% identity with a wild-type derived from one of Fusarium solani, Pseudomonas Mendocina or Humicola Insolens.

The relativity between two amino acid sequences is described by the parameter “identity”. For purposes of the present invention, the alignment of two amino acid sequences is determined by using the Needle program from the EMBOSS package (http://emboss.org) version 2.8.0. The Needle program implements the global alignment algorithm described in Needleman, S. B. and Wunsch, C. D. (1970) J. Mol. Biol. 48, 443-453. The substitution matrix used is BLOSUM62, gap opening penalty is 10, and gap extension penalty is 0.5.

Aesthetics—

The cleaning compositions may have any desired appearance or aesthetics. The composition may be opaque, transparent or translucent, of any color or appearance, such as a pearlescent liquid. The composition may contain air or gas bubbles, suspended liquid droplets, simple or multiple emulsion droplets, suspended particles and the like and combinations thereof.

Perfumes—

The composition may comprise a perfume, typically in the range from about 0.001 to about 3 wt %, or from about 0.1 to about 1 wt %. Many suitable examples of perfumes are provided in the CTFA (Cosmetic, Toiletry and Fragrance Association) 1992 International Buyers Guide, published by CFTA Publications and OPD 1993 Chemicals Buyers Directory 80^{th} Annual Edition, published by Schnell Publishing Co. It is usual for a plurality of perfume components to be present in the compositions of the invention, for example four, five, six, seven or more. In perfume mixtures preferably 15 to 25 wt % are top notes. Top notes are defined by Poucher (Journal of the Society of Cosmetic Chemists 6(2):80 [1995]). Preferred top notes include rose oxide, citrus oils, linalyl acetate, lavender, linalool, dihydromyrcenol and cis-3-hexanol. In some aspects, the perfume is encapsulated, such as a perfume micro capsule.

Hydrotropes—

The compositions disclosed herein may contain a hydrotrope. Illustrative hydrotropes include urea, toluene sulphonate, xylene sulphonate, cumene sulphonate or mixtures thereof. Illustrative salts include sodium, potassium, ammonium, monoethanolamine, triethanolamine or mixtures thereof. In some aspects, the hydrotrope is selected from xylene sulfonate, urea, or combinations thereof. The amount of the hydrotrope is in the range of from about 0.001% to about 10%, or from about 0.5% to 5%, or from about 1% to about 3%.

Structurant/Thickeners—

Structured liquids can either be internally structured, whereby the structure is formed by primary ingredients (e.g. surfactant material) and/or externally structured by providing a three dimensional matrix structure using secondary ingredients (e.g. polymers, clay and/or silicate material). The composition may comprise a structurant, typically from 0.01 wt % to 5 wt %, from 0.1 wt % to 2.0 wt %, by weight of the composition, structurant. The structurant is typically selected from diglycerides and triglycerides, ethylene glycol distearate, microcrystalline cellulose, cellulose-based materials, microfiber cellulose, biopolymers, xanthan gum, gellan gum, or mixtures thereof. A suitable structurant includes hydrogenated castor oil and non-ethoxylated derivatives thereof. A suitable structurant is disclosed in U.S. Pat. No. 6,855,680. Such structurants have a thread-like structuring system having a range of aspect ratios. Other suitable structurants and the processes for making them are described in WO2010/034736.

Boric Acid Derivatives and/or pH Jump Systems—

Another optional adjunct ingredient is boric acid or a boric acid derivative. Illustrative examples include boric acid, boric oxide, borax, alkali metal borates (such as sodium ortho-, meta- and pyroborate and sodium pentaborate), and mixtures thereof. Combinations of borates and polyols, especially sorbitol, constitute pH jump systems, see e.g., U.S. Pat. No. 5,089,163. In some aspects, the composition is substantially free of a pH jump systems. In other aspects, the composition disclosed herein may comprise less than about 3%, by weight of the composition, or less than about 1%, of boric acid derivatives.

Neutralizers—

The cleaning composition disclosed herein may comprise a neutralizer. The neutralizers may be acidic or alkali in character, depending upon what they will be neutralizing. Suitable neutralizers include, alkali metal hydroxides, such as NaOH, LiOH, KOH etc; alkaline earth hydroxides, such as Mg(OH)₂, Ca(OH)₂; ammonium or substituted ammonium hydroxides; alkanolamines, such as, mono-, di- and triethanolamines, for example, monoethanolamine (MEA); inorganic acids such as, sulfuric acid, hydrochloric acid, nitric acid; organic acids, such as acetic acids, citric acid, lactic acid and the like, or combinations thereof.

Fabric Hueing Agents—

The composition may comprise a fabric hueing agent (sometimes referred to as shading, bluing, or whitening agents). Typically the hueing agent provides a blue or violet shade to fabric. Hueing agents can be used either alone or in combination to create a specific shade of hueing and/or to shade different fabric types. This may be provided for example by mixing a red and green-blue dye to yield a blue or violet shade. Hueing agents may be selected from any known chemical class of dye, including but not limited to acridine, anthraquinone (including polycyclic quinones), azine, azo (e.g., monoazo, disazo, trisazo, tetrakisazo, polyazo), including premetallized azo, benzodifurane and benzodifuranone, carotenoid, coumarin, cyanine, diazahemicyanine, diphenylmethane, formazan, hemicyanine, indigoids, methane, naphthalimides, naphthoquinone, nitro and nitroso, oxazine, phthalocyanine, pyrazoles, stilbene, styryl, triarylmethane, triphenylmethane, xanthenes and mixtures thereof.

Suitable fabric hueing agents include dyes, dye-clay conjugates, and organic and inorganic pigments. Suitable dyes include small molecule dyes and polymeric dyes. Suitable small molecule dyes include small molecule dyes selected from the group consisting of dyes falling into the Colour Index (C.I.) classifications of Acid, Direct, Basic, Reactive or hydrolysed Reactive, Solvent or Disperse dyes for example that are classified as Blue, Violet, Red, Green or Black, and provide the desired shade either alone or in combination. In another aspect, suitable small molecule dyes include small molecule dyes selected from the group consisting of Colour Index (Society of Dyers and Colourists, Bradford, UK) numbers Direct Violet dyes such as 9, 35, 48, 51, 66, and 99, Direct Blue dyes such as 1, 71, 80 and 279, Acid Red dyes such as 17, 73, 52, 88 and 150, Acid Violet dyes such as 15, 17, 24, 43, 49 and 50, Acid Blue dyes such as 15, 17, 25, 29, 40, 45, 75, 80, 83, 90 and 113, Acid Black dyes such as 1, Basic Violet dyes such as 1, 3, 4, 10 and 35, Basic Blue dyes such as 3, 16, 22, 47, 66, 75 and 159, Disperse or Solvent dyes such as those described in US 2008/034511 A1 or U.S. Pat. No. 8,268,016 B2, or dyes as disclosed in U.S. Pat. No. 7,208,459 B2, and mixtures thereof. In another aspect, suitable small molecule dyes include small molecule dyes selected from the group consisting of C. I. numbers Acid Violet 17, Acid Blue 80, Acid Violet 50, Direct Blue 71, Direct Violet 51, Direct Blue 1, Acid Red 88, Acid Red 150, Acid Blue 29, Acid Blue 113 or mixtures thereof.

Suitable polymeric dyes include polymeric dyes selected from the group consisting of polymers containing covalently bound (sometimes referred to as conjugated) chromogens, (dye-polymer conjugates), for example polymers with chromogens co-polymerized into the backbone of the polymer and mixtures thereof. Polymeric dyes include those described in WO2011/98355, US 2012/225803 A1, US 2012/090102 A1, WO2012/166768, U.S. Pat. No. 7,686,892 B2, and WO2010/142503.

In another aspect, suitable polymeric dyes include polymeric dyes selected from the group consisting of fabric-substantive colorants sold under the name of Liquitint® (Milliken, Spartanburg, S.C., USA), dye-polymer conjugates formed from at least one reactive dye and a polymer selected from the group consisting of polymers comprising a moiety selected from the group consisting of a hydroxyl moiety, a primary amine moiety, a secondary amine moiety, a thiol moiety and mixtures thereof. In still another aspect, suitable polymeric dyes include polymeric dyes selected from the group consisting of Liquitint® Violet CT, carboxymethyl cellulose (CMC) covalently bound to a reactive blue, reactive violet or reactive red dye such as CMC conjugated with C.I. Reactive Blue 19, sold by Megazyme, Wicklow, Ireland under the product name AZO-CM-CELLULOSE, product code S-ACMC, alkoxylated triphenyl-methane polymeric colourants, alkoxylated thiophene polymeric colourants, and mixtures thereof.

Suitable hueing dyes include the whitening agents found in WO 08/87497 A1, WO2011/011799 and US 2012/129752 A1. Suitable hueing agents for use in the present invention may be the preferred dyes disclosed in these references, including those selected from Examples 1-42 in Table 5 of WO2011/011799. Other suitable dyes are disclosed in U.S. Pat. No. 8,138,222. Other suitable dyes are disclosed in U.S. Pat. No. 7,909,890 B2.

Suitable dye clay conjugates include dye clay conjugates selected from the group comprising at least one cationic/basic dye and a smectite clay, and mixtures thereof. In another aspect, suitable dye clay conjugates include dye clay conjugates selected from the group consisting of one cationic/basic dye selected from the group consisting of C.I. Basic Yellow 1 through 108, C.I. Basic Orange 1 through 69, C.I. Basic Red 1 through 118, C.I. Basic Violet 1 through 51, C.I. Basic Blue 1 through 164, C.I. Basic Green 1 through 14, C.I. Basic Brown 1 through 23, CI Basic Black 1 through 11, and a clay selected from the group consisting of Montmorillonite clay, Hectorite clay, Saponite clay and mixtures thereof. In still another aspect, suitable dye clay conjugates include dye clay conjugates selected from the group consisting of: Montmorillonite Basic Blue B7 C.I. 42595 conjugate, Montmorillonite Basic Blue B9 C.I. 52015 conjugate, Montmorillonite Basic Violet V3 C.I. 42555 conjugate, Montmorillonite Basic Green G1 C.I. 42040 conjugate, Montmorillonite Basic Red R1 C.I. 45160 conjugate, Montmorillonite C.I. Basic Black 2 conjugate, Hectorite Basic Blue B7 C.I. 42595 conjugate, Hectorite Basic Blue B9 C.I. 52015 conjugate, Hectorite Basic Violet V3 C.I. 42555 conjugate, Hectorite Basic Green G1 C.I. 42040 conjugate, Hectorite Basic Red R1 C.I. 45160 conjugate, Hectorite C.I. Basic Black 2 conjugate, Saponite Basic Blue B7 C.I. 42595 conjugate, Saponite Basic Blue B9 C.I. 52015 conjugate, Saponite Basic Violet V3 C.I. 42555 conjugate, Saponite Basic Green G1 C.I. 42040 conjugate, Saponite Basic Red R1 C.I. 45160 conjugate, Saponite C.I. Basic Black 2 conjugate and mixtures thereof.

The hueing agent may be incorporated into the detergent composition as part of a reaction mixture which is the result of the organic synthesis for a dye molecule, with optional purification step(s). Such reaction mixtures generally comprise the dye molecule itself and in addition may comprise un-reacted starting materials and/or by-products of the organic synthesis route.

Suitable pigments include pigments selected from the group consisting of flavanthrone, indanthrone, chlorinated indanthrone containing from 1 to 4 chlorine atoms, pyranthrone, dichloropyranthrone, monobromodichloropyranthrone, dibromodichloropyranthrone, tetrabromopyranthrone, perylene-3,4,9,10-tetracarboxylic acid diimide, wherein the imide groups may be unsubstituted or substituted by C1-C3-alkyl or a phenyl or heterocyclic radical, and wherein the phenyl and heterocyclic radicals may additionally carry substituents which do not confer solubility in water, anthrapyrimidinecarboxylic acid amides, violanthrone, isoviolanthrone, dioxazine pigments, copper phthalocyanine which may contain up to 2 chlorine atoms per molecule, polychloro-copper phthalocyanine or polybromochloro-copper phthalocyanine containing up to 14 bromine atoms per molecule and mixtures thereof. Other suitable pigments are described in WO2008/090091.

In another aspect, suitable pigments include pigments selected from the group consisting of Ultramarine Blue (C.I. Pigment Blue 29), Ultramarine Violet (C.I. Pigment Violet 15), Monastral Blue and mixtures thereof.

The aforementioned fabric hueing agents can be used in combination (any mixture of fabric hueing agents can be used).

### Water

The cleaning compositions generally contain from about 1 wt % to about 30 wt %, or from about 10% to about 25%, by weight of the cleaning composition, of water.

### Packaging for the Compositions

Commercially marketed executions of the compositions can be packaged in any suitable container including those constructed from paper, cardboard, plastic materials, e.g., polypropylene (PP), polyethylene (PE), polycarbonate (PC), polyamides (PA) polyethylene terephthalate (PET), polyvinylchloride (PVC), polystyrene (PS). In some aspects, the composition may be releasably stored in a water insoluble container, which may be opaque, transparent, or translucent, or partially so. In some aspects, the water insoluble container comprises a deformable container for storing the cleaning composition and a dispensing cap, where the deformable container has a bottom end and an opening in the bottom end, more specifically the opening comprises a slit valve adapted for dispensing, liquids, gels and/or pastes.

### Methods of Use

The present invention includes a method for cleaning a substrate or soiled material. Such method includes the steps of contacting the composition of the invention, in neat form or diluted in wash liquor, with at least a portion of the substrate, then optionally rinsing the substrate. Preferably the substrate is subjected to a washing step prior to the aforementioned optional rinsing step. For purposes of the present invention, washing includes, but is not limited to, scrubbing, wiping and mechanical agitation.

As will be appreciated by one skilled in the art, the cleaning compositions of the present invention are ideally suited for use in home care (hard surface cleaning compositions) and/or laundry applications.

### EXAMPLES

The following examples are included for purposes of illustration and not limitation. All percentages are percent by weight of the composition.

### Example 1

### Liquid Laundry Cleaning Compositions

The following liquid laundry cleaning compositions in Table 1 are prepared by traditional means known to those of ordinary skill in the art by mixing the following ingredients.

TABLE 1

| | A | B | C |
|---|---|---|---|
| | WT % | WT % | WT % |
| Ingredients | | | |
| AE_{1.8}S | 17.00 | 17.79 | |
| AE₃S | | | 11.00 |
| C_{11.8} linear alkyl benzene sulfonic | 2.80 | 2.96 | 1.05 |
| acid | | | |
| Mid-chain branched surfactant¹ | 14.70 | 15.42 | 22.00 |
| AE9² | 2.30 | 2.37 | 3.44 |
| Citric Acid Solution | 5.07 | 1.98³ | |
| Lactic Acid Solution | — | 6.51 | 6.57 |
| C₁₂-C₁₈ Fatty Acid | 2.36 | 2.47 | 1.50 |
| Protease (54.5 mg/g)⁴ | 7.62 | 7.98 | 2.08 |
| Amylase (29.26 mg/g)⁵ | 2.54 | 2.67 | 0.69 |
| Xyloglucanase⁶ | | | 0.15 |
| Borax | 4.72 | 4.94 | |
| Calcium Formate | 0.15 | 0.16 | 0.16 |
| Ethoxylated Polyethylenimine⁷ | 1.65 | 1.73 | 1.74 |
| Amphiphilic polymer ⁸ | | | 3.36 |
| Hexamethylene diamine, | | | 1.68 |
| ethoxylated, quaternized, sulfated ⁹ | | | |
| DTPA¹⁰ (50% active) | 0.28 | 0.30 | 0.64 |
| Tiron ® | 0.84 | 0.89 | |
| Optical Brightener¹¹ | 0.34 | 0.37 | 0.36 |
| Ethanol | 0.97 | 4.10 | 2.99 |
| Propylene Glycol | 4.90 | 5.16 | 8.49 |
| Diethylene Glycol | | | 4.11 |
| Monoethanolamine (MEA) | 1.12 | 1.17 | 0.23 |
| Caustic Soda (NaOH) | 3.50 | 3.74 | 2.10 |
| Na Formate | 0.61 | 0.64 | 0.23 |
| Na Cumene Sulfonate | | | 1.00 |
| Suds Suppressor | — | | 0.18 |
| Dye | 0.0025 | | 0.02 |
| Perfume | 0.85 | | 1.41 |
| Hydrogenated castor oil | | | 0.27 |
| PROPERTIES | | | |
| Neat pH | pH 4.2 | pH 5.0 | pH 5.0 |

¹C16/17 methyl branched alkyl sulfate, available from Shell (Neodol 67).
²AE9 is C12-14 alcohol ethoxylate, with an average degree of ethoxylation of 9, supplied by Huntsman, Salt Lake City, Utah, USA.
³Citric acid is introduced as a raw material impurity.
⁴Proteases may be supplied by Genencor International, Palo Alto, California, USA (e.g., Purafect Prime ®, Excellase ®) or by Novozymes, Bagsvaerd, Denmark (e.g. Liquanase ®, Coronase ®).
⁵Available from Novozymes, Bagsvaerd, Denmark (e.g., Natalase ®, Mannaway ®).
⁶Available from Novozymes (e.g., Whitezyme ®).
⁷Polyethyleneimine (MW = 600) with 20 ethoxylate groups per —NH.
⁸ Random graft copolymer is a polyvinyl acetate grafted polyethylene oxide copolymer having a polyethylene oxide backbone and multiple polyvinyl acetate side chains. The molecular weight of the polyethylene oxide backbone is about 6000 and the weight ratio of the polyethylene oxide to polyvinyl acetate is about 40 to 60 and no more than 1 grafting point per 50 ethylene oxide units, available from BASF as Sokalan PG101 ®.
⁹ A compound having the following general structure: bis((C₂H₅O)(C₂H₄O)ₙ)(CH₃)—N⁺—CₓH₂ₓ—N⁺—(CH₃)-bis((C₂H₅O)(C₂H₄O)ₙ), wherein n = from 20 to 30, and x = from 3 to 8, or sulphated or sulphonated variants thereof, available from BASF as Lutenzit Z 96 ®
¹⁰DTPA is diethylenetriaminepentaacetic acid supplied by Dow Chemical, Midland, Michigan, USA.
¹¹Suitable Fluorescent Whitening Agents are for example, Tinopal ® AMS, Tinopal ® CBS-X, Sulphonated zinc phthalocyanine Ciba Specialty Chemicals, Basel, Switzerland.

### Example 2

### Effect of pH/Neutralizing Agent on Composition Stability

The following compositions in Table 2 are prepared, and observations on their stability are recorded.

TABLE 2

| | Formulation | Formulation | Formulation |
|---|---|---|---|
| | 2.1 pH 3.0 | 2.2 pH 5.0 | 2.3 pH 5.0 |
| | WT % | WT % | WT % |
| | Active | Active | Active |
| Ingredients | | | |
| AE_{1.8}S | 16.3 | 16.3 | 16.3 |
| C_{11.8} linear alkyl benzene | 2.8 | 2.8 | 2.8 |
| sulfonic acid | | | |
| HSAS[1] | 13.6 | 13.6 | 13.6 |
| C24 alcohol, EO9[2] | 2.2 | 2.2 | 2.2 |
| Citric Acid | 0.9 | 0.9 | 0.9 |
| Lactic Acid | 5.8 | 5.8 | 5.8 |
| C₁₂-C₁₈ Fatty Acid | 2.3 | 2.3 | 2.3 |
| Protease (55.3 mg/g) [3] | 1.7 | 1.7 | 1.7 |
| Amylase (25.4 mg/g) [4] | 0.7 | 0.7 | 0.7 |
| Borax | 3.6 | 3.6 | 3.6 |
| Calcium Formate | 0.2 | 0.2 | 0.2 |
| Polyethyleneimine 600, | 1.6 | 1.6 | 1.6 |
| EO20 | | | |
| Polyethyleneimine 600, | 1.6 | 1.6 | 1.6 |
| EO24, PO16 | | | |
| DTPA[5] | 0.3 | 0.3 | 0.3 |
| Tiron ® [6] | 0.8 | 0.8 | 0.8 |
| Optical Brightener [7] | 0.3 | 0.3 | 0.3 |
| Ethanol | 4.4 | 4.4 | 4.4 |
| Propylene Glycol | 5.2 | 5.2 | 5.2 |
| Monoethanolamine | 1.1 | 1.1 | 1.1 |
| NaOH | 2.8 | 4.0 | 9.3 |
| Na Cumene Sulfonate | 1.1 | 1.1 | 1.1 |
| Na Formate | 0.2 | 0.2 | 0.2 |
| Dye | 0.1 | 0.1 | 0.1 |
| Perfume | 0.9 | 0.9 | 0.9 |
| Additional Water | 10.0 | 7.0 | 3.0 |
| PROPERTIES | | | |
| Stability | At least | At least | No stability - |
| | 3 days | 3 months | precipitation; |
| | | | appearance of |
| | | | striations and |
| | | | void spaces |

[1]HSAS is a mid-chain branched alcohol sulfate.
[2]Non-ionic ethoxylated alkyl alcohol available from Huntsman Corp., Austin, Tex.
[3] As described in US patent application 2011/0237487A1, incorporated herein by reference
[4] Termamyl Ultra 300L ® from Genencor
[5]DTPA is diethylenetriaminepentaacetic acid
[6] 4,5-Dihydroxy-1,3-benzenedisulfonic acid disodium salt, available from Sigma Aldrich
[7] Disodium 4,4′-bis{[4-anilino-6-morpholino-s-triazin-2-yl]-amino}-2,2′-stilbenedisulfonate (Brightener 15; CAS# 16090-02-1), available from Ciba

### Example 3

### Effect of pH on Enzyme Stability

The following test was performed to show the effect of water level on protease stability at various pHs.

Preparation of Samples:

A sample of according Formula A of Table 3 was made, leaving formulation space to adjust pH, to level the water across the samples, and to add enzymes. The formula was aliquoted into 8 samples; the pH of each sample was adjusted to pH 3.5, 4.0, 4.5, 5.0, 5.5, 6.0, 6.5 and 7.5, respectively, with NaOH or H₂SO4 as needed. The total weight of each sample was then adjusted to make the water level equal in all aliquots. Three samples, all of Formula A, were then weighed out at each pH level. The water level of Formula A, when finished with enzyme, was approximately 24%. Two of the three samples of A (at each pH) were diluted with water to form Formulas B and C, having water levels of approximately 40% and 55%, respectively, when finished with enzyme.

The day that the enzymes are added is designated as Day 1. The initial protease enzyme activity levels were measured approximately two hours after the enzyme addition. Activity levels were also measured after two weeks of storage at 35° C. and at the desired pHs. The enzyme activity level is reported as a percentage relative to the initial activity level, and the method of measuring protease activity is described below.

Measuring Protease Activity:

Prepare a diluent solution of 0.5 g calcium chloride dihydrate (Sigma-Aldrich, cat. # C-5080) and 10 g sodium thiosulfate pentahydrate (Sigma-Aldrich, cat. # S-6672) in 1 liter of deionized water (18.2 mega Ohms MΩ or better). Prepare a TRIS buffer of 12.1 g tris-hydroxymethyl-aminomethane (Sigma-Aldrich, cat. #—1503), 1.1 g of calcium chloride dihydrate and 5.0 g sodium thiosulfate pentahydrate, pH 8.3 in 1 liter of deionized water. Prepare a working PNA solution by diluting 250 uL of a 1 gram of N-Succinyl-ALA-ALA-PRO-PHE p-nitroanilide (“PNA”; Sigma-Aldrich, cat. # S-7388) per 10 mL dimethyl sulfoxide (J.T. Baker, cat. # JT9224-1) into 25 mL TRIS buffer.

Protease analysis is carried out by reaction of a protease containing sample with Succinyl-Ala-Ala-Pro-Phe p-nitroanilide resulting in a change in absorbance over time spectrophotometrically. The response is proportional to the level of protease present in the sample. The protease sample is prepared by dilution in the diluent solution. The reaction begins by incubation of 250 uL of working PNA solution at 37° C. for 360 seconds then delivery of 25 uL sample preparation and monitoring change in absorbance at 405 nm. The protease active level is determined by relation to a protease level vs. reaction rate calibration established for that specific protease. For example, a reference curve may be established by measuring post-reaction absorbance as described above over a range of known enzyme concentrations, for example, from about 1 mg enzyme/100 g product to about 100 mg enzyme/100 g product.

TABLE 3

| | A | B | C |
|---|---|---|---|
| | (24% water) | (40% water) | (55% water) |
| | WT % | WT % | WT % |
| Ingredients | Active | Active | Active |
| AE3S | 13.06 | 10.31 | 7.72 |
| C11.8 HLAS | 1.05 | 0.83 | 0.62 |
| HSAS [1] | 20.51 | 16.18 | 12.13 |
| C24 alcohol, EO9 [2] | 3.44 | 2.71 | 2.03 |
| Lactic Acid | 6.33 | 4.99 | 3.74 |
| C1218 FATTY ACID | 1.50 | 1.18 | 0.89 |
| Protease (55.3 mg/g) [3] | 2.08 | 1.64 | 1.23 |
| Amylase (25.4 mg/g) [4] | 0.80 | 0.63 | 0.47 |
| Xylogluconase (20 mg/g) [5] | 0.15 | 0.15 | 0.15 |
| Calcium Formate | 0.16 | 0.13 | 0.09 |
| Polyethyleneimine 600, | 1.74 | 1.37 | 1.03 |
| EO20 | | | |
| Polyethyleneimine 600, | 1.68 | 1.33 | 0.99 |
| EO24, PO16 | | | |
| Sokalan PG101 ® [6] | 1.68 | 1.33 | 0.99 |
| DTPA [8] | 0.29 | 0.23 | 0.17 |
| Optical Brightener [10] | 0.19 | 0.15 | 0.11 |
| Ethanol | 2.99 | 2.36 | 1.77 |
| Propylene Glycol | 8.50 | 6.71 | 5.03 |
| Diethylene Glycol | 4.11 | 3.24 | 2.43 |
| Monoethanolamine (MEA) | 0.23 | 0.18 | 0.14 |
| NaOH | 2.60 | 2.05 | 1.54 |
| Na Cumene Sulfonate | 1.00 | 0.79 | 0.59 |
| Na FORMATE | 0.24 | 0.19 | 0.14 |
| Structurant [11] | 0.27 | 0.21 | 0.16 |
| Sud supressor | 0.18 | 0.14 | 0.11 |
| Dye | 0.08 | 0.06 | 0.05 |
| Perfume | 1.18 | 0.93 | 0.70 |
| Total WT % actives | 76.04 | 60.03 | 45.04 |
| Water | Balance | Balance | Balance |
| | (24%) | (40%) | (55%) |

[1] HSAS is a mid-chain branched alcohol sulfate.
[2] Non-ionic ethoxylated alkyl alcohol available from Huntsman Corp., Austin, Tex.
[3] As described in US patent application 2011/0237487A1, incorporated herein by reference
[4] Termamyl Ultra 300L ® from Genencor
[5] Whitezyme ® From Novozymes
[6] co-polymer of polyethylene glycol and vinyl acetate available from BASF
[8] DTPA is diethylenetriaminepentaacetic acid.
[10] Disodium 4,4′-bis{[4-anilino-6-morpholino-s-triazin-2-yl]-amino}-2,2′-stilbenedisulfonate (Brightener 15; CAS# 16090-02-1), available from Ciba
[11] Hydrogenated castor oil

TABLE 4
Protease Stability.
Protease Stability after 2 Weeks at 35° C.

| | Formula A | Formula B | Formula C |
|---|---|---|---|
| | (25% water) | (40% water) | (55% water) |
| pH | % of Initial | % of Initial | % of Initial |
| 3.47 | 0 | 0 | 0 |
| 3.95 | 3 | 0 | 0 |
| 4.44 | 54 | 0 | 0 |
| 4.97 | 83 | 28 | 0 |
| 5.45 | 94 | 73 | 20 |
| 6.07 | 97 | 85 | 57 |
| 6.57 | 94 | 92 | 74 |
| 7.5 | 99 | 95 | 82 |

Table 4 shows protease stability at varying water levels and at various pHs. In general, compositions with lower levels of water provide surprisingly improved enzyme stability compared to equivalent compositions with higher levels of water.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A compact fluid laundry detergent composition comprising:
a. from about 30% to about 65%, by weight of the composition, of a surfactant system, wherein said surfactant system comprises from about 35% to about 70%, by weight of the surfactant system, of a branched anionic surfactant;
b. from about 4% to about 15%, by weight of the composition, of a water soluble organic acid;
wherein the composition has a pH of from about 2 to about 7.

2. A composition according to claim 1, wherein said composition comprises from about 0.05% to about 2.0% of an alkanolamine.

3. A composition according to claim 1, wherein said composition comprises from about 0.05% to about 0.8% of an alkanolamine.

4. A composition according to claim 1, wherein said surfactant system comprises a nonionic surfactant.

5. A composition according to claim 4, wherein the ratio of anionic surfactant to nonionic surfactant is from about 3:1 to about 15:1.

6. A composition according to claim 1, wherein said composition has a neat pH of from about 3 to about 6.

7. A composition according to claim 1, wherein said composition has a neat pH of from about 4 to about 5.5.

8. A composition according to claim 1, wherein said composition has a viscosity of from about 300 cps to about 10,000 cps measured at 1 s⁻¹ at 21.1° C.

9. A composition according to claim 1, wherein said composition has a viscosity of from about 600 cps to about 8,000 cps measured at 1 s⁻¹ at 21.1° C.

10. A composition according to claim 1, wherein said water soluble organic acid comprises no more than six carbons.

11. A composition according to claim 10, wherein said water soluble organic acid is selected from the group consisting of citric acid, lactic acid, acetic acid, and mixtures thereof.

12. A composition according to claim 1, wherein said composition further comprises an organic solvent.

13. A composition according to claim 1, wherein said composition comprises from about 6% to about 10%, by weight of the composition, of said water soluble organic acid.

14. A composition according to claim 1, wherein said composition comprises from about 10% to about 45% water.

15. The composition according to claim 1, wherein at least about 10% of said branched anionic surfactant is sulfated.

16. The composition according to claim 1, wherein said composition comprises an adjunct cleaning additive selected from a polymeric dispersing agent, an alkoxylated polyamine polymer, a modified hexamethylenediamine, an amphiphilic graft co-polymer, a modified or unmodified polyacrylate, or a mixture thereof.

17. The composition according to claim 1, wherein said composition comprises from about 0.001% to about 1% by weight of enzyme.

18. The composition according to claim 17, wherein said enzyme is selected from lipase, amylase, protease, mannanase, or combinations thereof.

19. The composition according to claim 1, wherein said composition comprises a hueing agent.

20. The composition according to claim 1, wherein said composition comprises an adjunct cleaning additive selected from builders, structurants or thickeners, enzyme stabilizing systems, bleaching compounds, bleaching agents, bleach activators, bleach catalysts, brighteners, dyes, hueing agents, dye transfer inhibiting agents, chelating agents, suds supressors, softeners, perfumes, processing aids, or mixtures thereof.

21. A method for treating a substrate, comprising the step of contacting the substrate with the composition of claim 1.
